(19) United States
(12) Patent Application Publication
(10) Pub. No.: US 2007/0226148 A1
(43) Pub. Date: Sep. 27, 2007

(54) Image processing apparatus and license management method thereof

(75) Inventor: Tatsuo Noda, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/385,705

(22) Filed: Mar. 22, 2006

(51) Int. Cl. G06Q 99/00

(52) U.S. Cl. 705/59

(57) ABSTRACT

The present invention is a license management method capable of managing licenses given to an image processing apparatus while ensuring security and of easily granting the licenses. The image processing apparatus having a program storage means which stores a program for performing an option function validated only while the license is granted is prepared. Licenses are stored in a memory device 12, an MFP 1 which intends to acquire a license accesses to the memory device 12, identification information of the accessed MFP is associated with the license to be granted and stored in the memory device 12, the license associated with the identification information and stored in the memory device 12 is granted to the MFP 1 and the license is prevented from being granted to another MFP as already being granted.

### FIELD OF THE INVENTION

The present invention relates to an image processing apparatus equipped with a program, in particular, an image processing apparatus equipped with a program validated by granting a license and a management method of the license.

### BACKGROUND OF THE INVENTION

Conventionally, an image processing apparatus such as a printer or a multi function processing machine each having different functions according to price has been put on the market as a different product (different grade, different model, etc.). However, in the image forming apparatus, a difference in grade or model does not necessarily mean a difference in basic hardware configuration, but only in programs for realizing various functions.

When developing programs, a basic program and a plurality of option programs associated with each other are generally developed together; only option programs are not developed at a later time. That is, the following marketing method is adopted: the basic program and the option programs have been already made and stored in a memory chip or the like of an image processing apparatus. Then, the on-board option programs are selectively validated according to the price and the image processing apparatus is marketed as a product (for example, refer to Japanese Unexamined Patent Publication No. 2001-092779).

In the case of relative models, a lower grade model is pre-installed with option programs to have the same specification as an upper grade model. The user who purchases the lower grade model can purchase a license for the option programs later to validate the option programs.

In such case, it is configured that the acquired (purchased) license includes device identification information and only when the device identification information agrees, the option program can be validated by the granted license (refer to Japanese Unexamined Patent Publication No. 2004-213469).

In the license issue and grant method as disclosed in the above-mentioned Japanese Unexamined Patent Publication No. 2004-213469, it is necessary to previously inform a license management center for identification information of the device to which a license should be granted to acquire the license having the device identification information therein. For this reason, this takes some time and efforts for the service person and user of the image processing apparatus.

Furthermore, once a license is granted, the license generally cannot be returned. Thus, when short-time use of a particular option program installed in the image processing apparatus is intended for a rental purpose, use in exhibitions and other purposes, the conventional license issue and grant method cannot satisfactorily address it.

### SUMMARY OF THE INVENTION

Under such circumstances, a main object of the present invention is to provide a license management method for an image processing apparatus in which a license can be returned when the license becomes unnecessary while ensuring security of the license.

Another object of the present invention is to provide an image processing apparatus in which a program for performing an option program validated only while a license is granted, the image processing apparatus being capable of stably granting and returning the license with simple operations while maintaining high security of the license.

Still another object of the present invention is to provide a license management method of managing the license granted to the image processing apparatus while ensuring security and easily granting the license.

An aspect of the present invention is a license management method for an image processing apparatus which stores a program therein and can validate the stored program by granting a license to perform a predetermined function comprising the steps of generating a license return code on the basis of device-specific information of the image processing apparatus in response to a license return operation made in the image processing apparatus, determining whether or not a license management means has issued a license including the device-specific information contained in the license return code by giving the generated license return code to the license management means, and registering that the license is returned in the license management means when the above license is issued and refunding license fee.

According to the invention, when it is intended that the license granted to the image processing apparatus is returned, the license return operation may be performed. In response to the license return operation, the image processing apparatus generates the license return code on the basis of the own device-specific information. It is preferred that the service person of the image processing apparatus, not the user of the image processing apparatus, performs the license return operation.

The license return code generated in response to the license return operation is given to the license management means by the service person. The license management means is formed of a license management server. Since the license management server can be accessed from any place via a network, it is an advantage that the license can be easily returned.

In the license management means, when the license return code is received, determination is made whether or not the license including the device-specific information contained in the license return code is issued. Generally, the determination is made that the license is issued. However, for example, when the license return operation is performed and the license return code is generated in the image processing apparatus although the license is not granted, the determination is made that the license is not issued.

When the license is issued, the issued license is returned to the license management means. Then, the license management means holds the license so as to be available for another image processing apparatus. Usage fee (license fee) of the returned license is refunded.

It is preferred that in the image processing apparatus which generates the license return code, the same license as the returned license is prevented from being registered for a certain period of time. As a result, it is possible to prevent unauthorized license use such as returning the license and reregistering the license in the image processing apparatus without authorization.

Furthermore, it is preferred that the license is granted to only the image processing apparatus having the device-specific information contained in the license issue code. Thus, security of the license can be ensured.

Furthermore, it is preferred that the license issue code includes a time limit for registration. As a result, when the license issue code is not registered in the predetermined image processing apparatus within the certain period of time, the issued license is made invalid. Thus, the time during which the license is not granted to the image processing apparatus is limited, thereby improving security of the license.

Another aspect of the present invention is an image processing apparatus comprising a program storage means which stores a program for performing an option function validated only while a license is granted, an access means which can access to a license management file in which licenses are registered, a display means which displays the licenses registered in the license management file accessed by the access means thereon, based on that a license to be granted is identified among the licenses displayed on the display means, a means which outputs own identification information to the license management file to associate own identification information with the license to be granted and register the own identification information in the license management file, and based on that the own identification information is registered in the license management file, a means which stores that the license is granted and validates the program stored in the program storage means for performing the option function of the license.

Still another aspect of the present invention is a license management method of granting a license to an image processing apparatus having a program storage means which stores a program for performing an option function validated only while the license is granted to validate the program, and of managing the granted license comprising the steps of storing licenses in a portable storage unit, causing an image processing apparatus which intends to acquire a license to access to the portable storage unit, associating identification information of the accessing image processing apparatus with the license to be granted and storing the identification information in the portable storage unit, granting the license associated with the identification information and stored in the portable storage unit to the image processing apparatus, and preventing the license from being granted to another image processing apparatus.

According to the above-mentioned invention, in issuing the license, even when information (identification information) of the image processing apparatus is not previously found, the license can be issued. When the issued license is granted to the image processing apparatus and the program for performing the option function of the image processing apparatus is validated, the identification information of the image processing apparatus is acquired, and the identification information is associated to the license and registered in the license management file.

Thus, even when the license is issued in the state where the identification information of the image processing apparatus is not previously found, at the time when the license is granted to the image processing apparatus, both the license and the identification information of the image processing apparatus are registered in the license management file and thus security of the license can be ensured.

It is preferred that the license granted to the image processing apparatus once can be returned with a simple operation. The returned license can be granted to another image processing apparatus. For this reason, the license is easier to handle and has higher versatility than the conventional license. Also in this case, as described above, security of the license is ensured.

In the case where the storage unit used for granting the license to the image processing apparatus is damaged and the damage is recovered, when at least the identification information of the image processing apparatus is properly recovered, the license can be advantageously reissued with ease.

By storing the license management file in the portable storage unit (for example, a memory card and an IC card), the service person of the image processing apparatus can carry the license management file with him/her and when the option program of the image processing apparatus used by the user is validated, the service person can easily grant the license by using the portable storage unit.

When the image processing apparatus makes the license management file accessible via the network, it is possible to realize more flexible license grant.

### BRIEF DESCRIPTION OF THE DRAWINGS

FIG. 1 is a block diagram showing a configuration of an MFP (Multi Function Peripheral) used in a first embodiment of the present invention.

FIG. 2 is a schematic view for describing a license issue procedure to the MFP.

FIG. 3 is a schematic view for describing a license return procedure.

FIG. 4 is a block diagram showing a system configuration in accordance with a second embodiment of the present invention.

FIG. 5 is a schematic view showing a configuration of license management files stored in a memory device.

FIG. 6 is a control flow chart of license grant in the system shown in FIG. 4.

FIG. 7 is a control flow chart of license return in the system shown in FIG. 4.

### BEST MODE FOR CARRYING-OUT OF THE INVENTION

Embodiments of the present invention will be specifically described below with reference to figures.

The following embodiment will be described using an image processing apparatus capable of performing a plurality of functions (hereinafter referred to as an MFP (Multi Function Peripheral)) as an example.

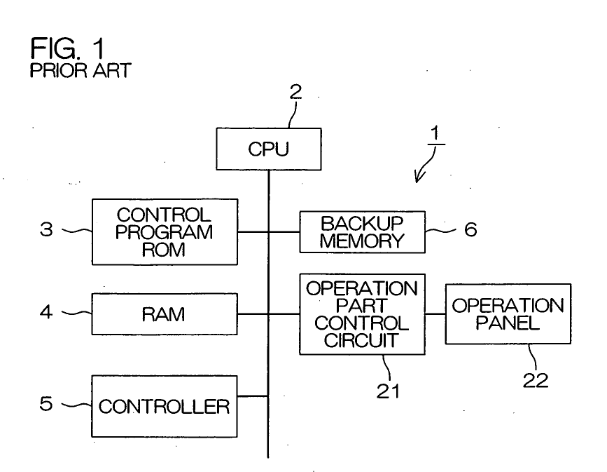

FIG. 1 is a block diagram showing configuration of an MFP used in a first embodiment of the present invention. The MFP 1 includes a CPU 2, a control program ROM 3, a RAM 4, a controller 5, a backup memory 6, an operation part control circuit 21 and an operation panel 22.

The CPU 2 is a control center which controls the whole MFP 1, and the control program ROM 3 is a nonvolatile memory which stores a control program for controlling the whole MPF 1 therein. In the control program ROM 3 is stored a basic program for performing a predetermined function of the MFP 1 and a program for performing an option function validated when a license is granted.

The RAM 4 is a memory necessary for operating the programs stored in the control program ROM 3.

The controller 5 is an apparatus to be controlled and includes a printer function performing device, a FAX function performing device and scanner function performing device.

The backup memory 6 is a memory which stores backup information of the whole MFP 1 therein and record on whether or not the option program is authorized by the license (record that the license is granted) is backed up in the backup memory 6.

The operation part control circuit 21 is a circuit which controls the operation panel 22, accepts an input of a license issue code and controls a license return code generation screen and the like. The operation panel 8 includes a display device such as an LCD and an input device such as a keyboard, and is required to display an input request screen of the license issue code, input the license issue code and accept a license return operation to perform display for license return.

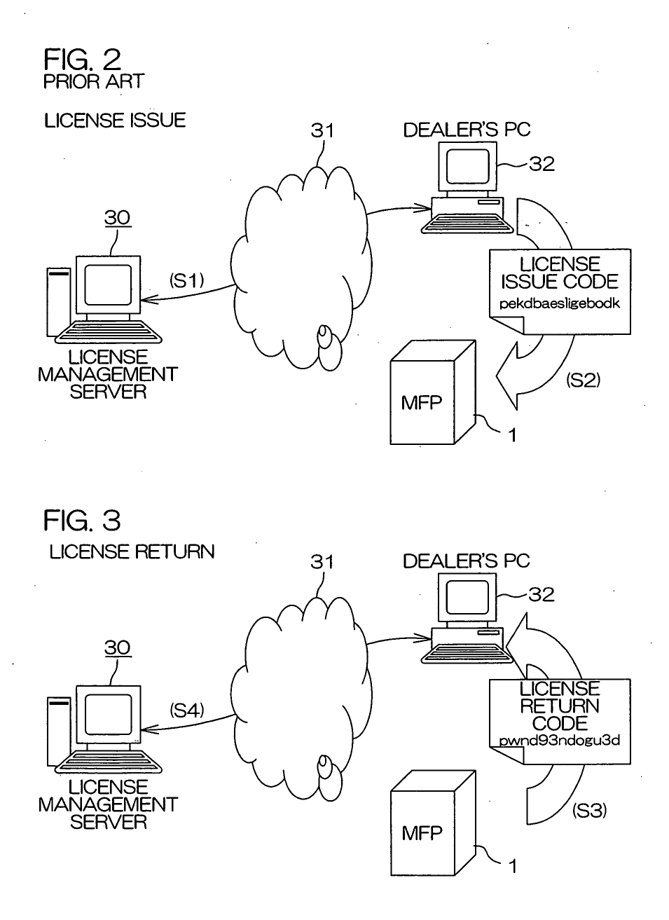

FIG. 2 is a view for describing a license issue procedure and FIG. 3 is a view for describing a license return procedure.

Prior to descriptions of the issue and return of the license, the background of the present invention will be briefly described.

A MPF manufactured by a manufacturer previously stores a program for performing a basic operation and a plurality of option programs for performing option functions therein. For the manufacturer, such MPF has an advantage that products having a common hardware and program structure can be manufactured all together.

On the other hand, a user hopes to acquire the MFP which performs only a desired function at a lower price. That is, the user hopes to purchase the MFP having only a necessary function rather than many complicated option functions at a lower price.

To adjust difference between views of the manufacturers and the user and provide an MFP desired by the users, a concept of granting the license for the option function has been proposed (refer to Japanese Unexamined Patent Publication No. 2001-092779, for example).

The license is provided to validate the option program previously installed in the MFP and the license itself is an intangible asset. That is, unlike conventional option components, a hardware member is not additionally attached to the MFP. Although the license is an intangible asset, in the MFP that the manufacturer produces and develops at a large cost, the license is a very valuable property for validating the option function for a charge. Therefore, the issue (grant) and management of the license becomes a very important element for the manufacturers. For the dealer selling the MFP, it is important in terms of business to sell the license as an intangible asset as a product similar to hardware itself by selling the license to the sold MFP and causing the user to return the license as well as to sell the MFP as hardware.

Against this background, in FIGS. 2 and 3, the manufacturer, for example, manages the licenses for the MPF 1 all together and owns a license management server 30 for this purpose. The license management server 30 is connected to a network 31 and the network 31 is connected to a dealer's personal computer 32. Thus, the dealer's personal computer 32 can access to the license management server 30 via the network 31. The dealer accesses to the license management server 30 by using the dealer's personal computer 32 and have the license issued. Then, the dealer sells the issued license to the user or grants the license to the managed MFP.

Referring to FIG. 2, a license issue procedure will be described.

The dealer accesses to the license management server 30 by using the dealer's personal computer 32 and informs the license management server 30 of device-specific information of the MFP 1 managed by the dealer (S1).

The license management server 30 generates a license issue code on the basis of the informed device-specific information. A license is issued by transmitting the generated license issue code to the dealer's personal computer 32.

The dealer extracts the license issue code transmitted to the dealer's personal computer 32 and inputs the code to the MFP 1 (S2). The MFP 1 compares the code with own device-specific information to confirm whether of not the input license issue code is correct.

As a result, when the license issue code is correct, assuming that the MFP 1 has acquired the license, license presence is set in backup data in the apparatus to make a predetermined program operable.

The license issue procedure has been described above. This procedure is substantially same as a procedure described in Japanese Unexamined Patent Publication No. 2004-213469.

Next, a license return procedure as a feature of the first embodiment will be described with reference to FIG. 3.

The dealer performs a license return operation in the MFP 1, the license for which is returned. This operation is performed using the operation panel 22 of the MFP 1.

When the license return operation is performed, the MFP 1 generates a license return code on the basis of the own device-specific information and displays the code on the operation panel 22 (S3). At this time, even when the corresponding license is not registered, the license return code can be generated.

The dealer confirms the license return code displayed on the operation panel 22, accesses to the license management server 30 using the dealer's personal computer 32 and transmits the license return code from the dealer's personal computer 32 to the license management server 30 (S4).

The license management server 30 confirms whether or not the corresponding device-specific information license is issued and when it is issued, returns the license and performs an operation of refunding money to the user.

To prevent unauthorized use in the issue or return of the license, the following processing may be performed. The “unauthorized use” herein refers to a case where immediately after returning the license, the user reregisters the same license as the returned license for the MFP, thereby having money refund while getting the license.

To prevent such unauthorized use, (1) time information is embedded in the license issue code at the time of license issue to set a time limit during which the license should be registered. Unless the license is registered in the MFP 1 within the time limit, the generated license issue code is made invalid.

(2) When the license return operation is performed, the MFP 1 rejects license registration to the same type of license for a predetermined time. Unauthorized registration is prevented by setting the predetermined time longer than a license validity time.

When the time limit is set in the license issue code and registration is not performed within the time limit, the user is requested to return the license once, which enables reissue of the license. Since the “license return code” can be generated even when the license is not registered, this processing is possible.

Since this embodiment is configured as described above, temporary license issue such as license issue to a rental MFP 1 is possible.

The license in this embodiment may be a license for validating a program for a basic operation itself such as a copying operation as well as a license for validating the program for the option function.

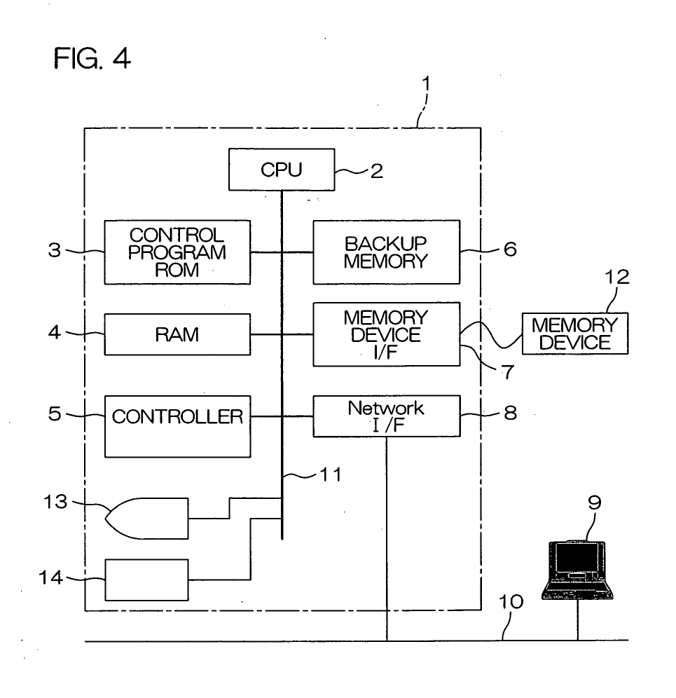

FIG. 4 is a block diagram of a system configuration in accordance with a second embodiment of the present invention. An MFP 1 includes the CPU 2, the control program ROM 3, the RAM 4, the controller 5, a display part 13, an operation part 14, a backup memory 6, a memory device interface 7 and a network interface 8.

The CPU 2, the control program ROM 3, the RAM 4, the controller 5 and the backup memory 6 are equivalent to those described in the first embodiment.

The memory device interface 7 is an interface for connecting to an external memory device. Specific examples include such as an USB, or a CF connector. When the MFP 1 is equipped with the memory device interface 7, as described later, a memory device 12 which stores license management files therein can be attached to the MFP 1.

The network interface 8 is an interface necessary for transmitting or receiving data to or from an external personal computer 9 via a network 10.

The above-mentioned components including the CPU 2 in the MFP 1 are connected to each other via a connection bus 11.

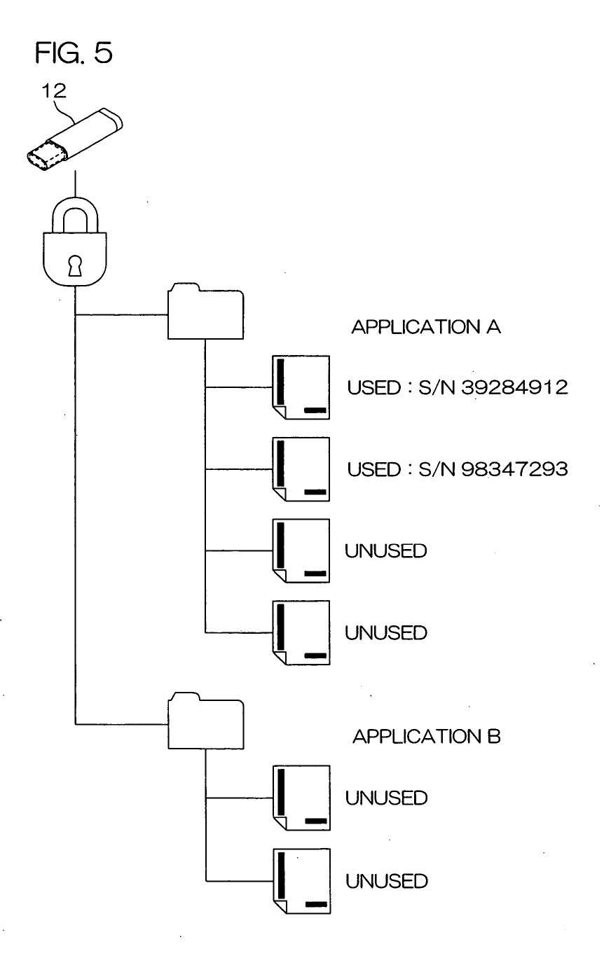

FIG. 5 is a schematic view showing a configuration of the license management files stored in the memory device 12.

The memory device 12 contains two kinds of licenses of an application A and an application B. The application A is, for example, a license for authorizing an option program for performing a hard disk clearing function. The application B is, for example, a license for authorizing an option program for adding a new format using the network interface 8.

In FIG. 5, four license files of the application A are stored, two files of them are used and remaining two files are unused. Two license files of the application B are stored and both of them are unused. That is, among the four license files in which the licenses of the application A are stored, “S/N39284912” and “2/N98347293” stored in the two license files are identification numbers of an authorized image processing apparatus.

The configuration of the license management files stored in the memory device 12 shown in FIG. 5 is merely an example and contents of the stored license management files may be varied depending on the capacity of the memory device 12 or the like.

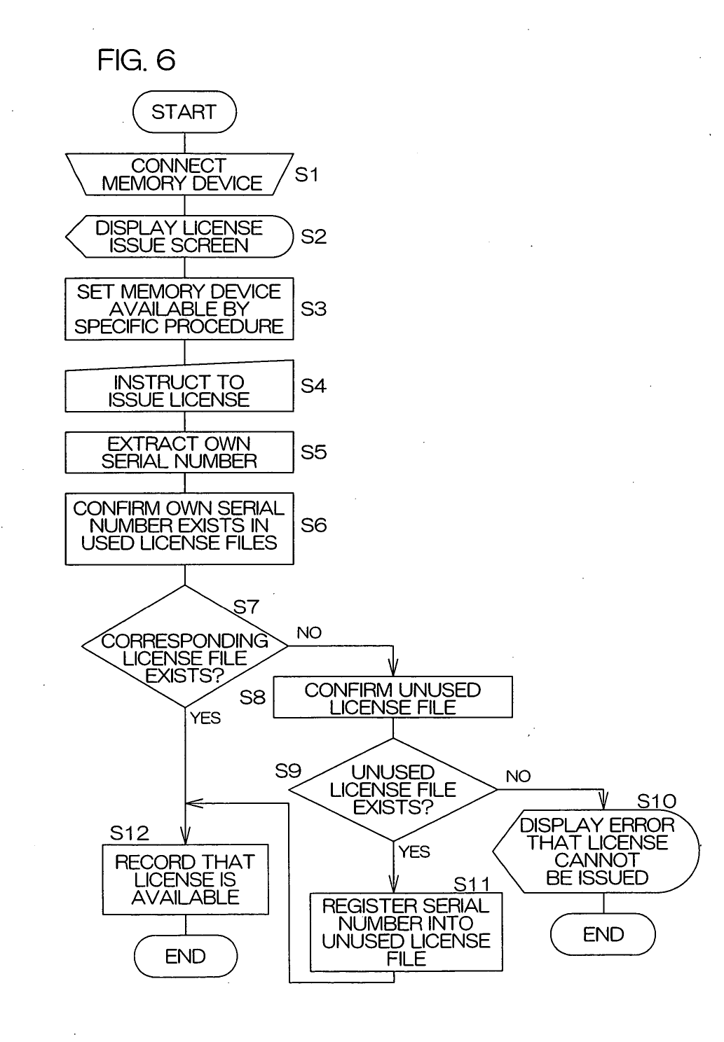

FIG. 6 is a flow chart of the case where the license is granted in the system shown in FIG. 4. Referring to FIGS. 4 and 5, a control operation of license grant in this embodiment will be described according to the flow chart of FIG. 6.

When the user informs an intent to activate the option function of the MFP 1, a service person of the MFP 1 connects the memory device 12 to the MFP 1 via the memory device interface 7 (step S1). When connecting the memory device 12 to the memory device interface 7, when the memory device 12 does not support so-called hot swap, as a matter of course, the power of the MFP 1 is turned off to connect.

The service person operates the operation panel 14 and displays a license issue screen on the display part 13 (step S2). With the display of the license display screen, the MFP main unit (CPU 2) accesses to the connected memory device 12 so that contents of the memory device 12 can be viewed according to a predetermined procedure. Specifically, for example, a password code is transmitted to the memory device 12 so that the memory device 12 can be connected as a file (step S3).

Next, the CPU 2 displays the type of license that the memory device 12 can grant on the display part 13. In this case, the CPU 2 compares the applications stored in the control program ROM 3 with the applications stored in the memory device 12 and displays the matched application, that is, the function which is valid when the license is granted, to instruct which function should be validated (step S4).

Subsequently, when the license to be granted is instructed, the CPU 2 extracts own identification information (serial number) (step S5). Then, the CPU 2 follows the instruction from the service person on the basis of the operation of the operation part 14 and searches whether or not a file which stores the associated own serial number therein exists in the instructed application (step S6). In other words, it is confirmed whether or not the own identification information is associated with the desired license and registered in the license management file.

As a result, when the corresponding license file exists (YES at a step 7), since the license is already granted, the fact that the use based on the license is possible is recorded in the backup memory 6 (step S12) to finish processing.

On the other hand, when he corresponding license file does not exist (NO at the step 7), it is confirmed whether or not an unused license file exists in files of the memory device 12 (step S8).

As a result, when determination is made that the unused license file exists (YES at a step 9), the own serial number read by the CPU 2 is registered in the unused license file (step S11) and the fact that the license is granted is recorded in the backup memory 6 (step S12).

On the other hand, when the unused license file does not exist (NO at the step S9), an error that the license cannot be granted is displayed on the display part 13 to finish processing (step S10).

There has been described the example in which the service person executes the license grant processing in the MFP 1 using the display part 13 and the operation part 14 which are installed in the MFP 1. In place of this, however, the above-mentioned license grant processing can be executed using the personal computer 9 connected to the network 10.

In this case, two steps of the step S5 “extract own serial number” and the step S12 “record that license is available” in the control flow chart of FIG. 6 may be performed at the side of the MFP 1 via the network 10 from the personal computer 9 and all of the remaining steps may be performed at the side of the personal computer 9.

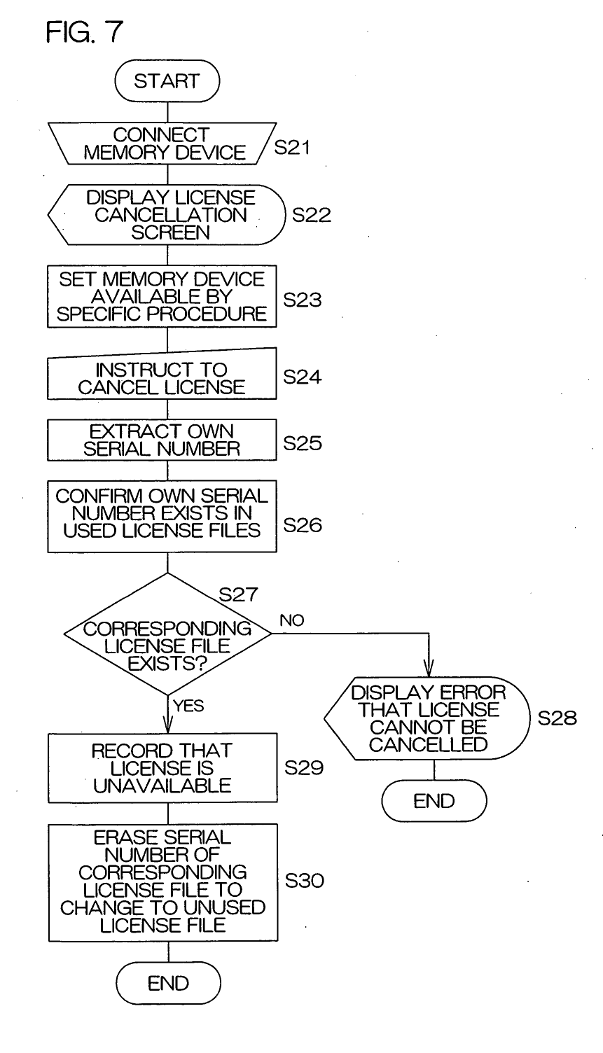

FIG. 7 is a control flow chart in the case where the license granted to the MFP 1 is returned. When the application to which the license is granted becomes unnecessary, the user of the MFP 1 need not pay subsequent license fee by returning the license. Advantageously, the manufacturer (dealer) can grant the license to another MFP.

Thus, in this embodiment, the granted license can be returned in the following manner.

The service person connects the memory device 12 to the MFP 1 via the memory device interface 7 (step S21).

Next, the service person operates the operation part 14 and displays a license cancellation screen on the display part 13 (step S22).

The CPU 2 performs processing to the connected memory device 12 so that contents of the memory device 12 can be viewed according to a predetermined procedure. Specifically, the password code is transmitted to the memory device 12 so that the memory device 12 can be connected as a file (step S23).

Next, the CPU 2 displays a list of valid licenses on the display part 13. Then, an instruction on which license should be cancelled is given (step 24).

Subsequently, the CPU 2 extracts the own serial number (step S25) and according to the instruction from the service person, searches whether or not a file in which the own serial number is described exists in the instructed application (step S27).

As a result, determination is made whether or not the corresponding license file exists (step S27) and when the corresponding license file does not exist, an error that the license cannot be cancelled is displayed on the display part 13 to finish processing (step S28).

On the other hand, when the corresponding license file exists, the record stored in the backup memory 6 that the license is granted is changed to a record that no license exists (license is returned) (step S29), the own serial number (identification information) recorded in the license management file of the memory device 12 is erased, and the file is changed to the unused license file (step S30).

This processing can be also performed by using the personal computer 9 connected to the network 10 instead of operating the MFP 1 itself by the service person.

In terms of a management policy, it is useful to handle with the license management files stored in the memory device 12 as follows.

That is, for example, the manufacturer issues numerous licenses (for example, 500 licenses) stored in a master memory device and sells to a certain dealer. Using a tool such as a personal computer which stores a specific program therein, the dealer subdivides the licenses in the master memory device into small lots and stores a plurality of licenses in a plurality of memory devices, respectively. The service person owns and manages one or some of the subdivided memory devices as own memory device and makes a necessary option function program in the MFP of each user operable by using the memory device.

In this manner, the dealer can collectively manage the licenses stored in the memory device owned by each service person.

The present invention is not limited to the above-mentioned embodiments and various modification can be made within the scope of the claims.

The disclosure of Japanese patent application Serial Nos. 2005-92492, and 2005-92493, both filed on Mar. 28, 2005, is incorporated herein by reference.

What is claimed is:

1. A license management method for an image processing apparatus which stores a program therein and can validate the stored program by granting a license to perform a predetermined function comprising the steps of:
generating a license return code on the basis of device-specific information of the image processing apparatus in response to a license return operation made in the image processing apparatus;
determining whether or not a license management means issues a license including the device-specific information contained in the license return code by giving the generated license return code to the license management means; and
registering that the license is returned in the license management means when the above license is issued and refunding license fee.

2. A license management method according to claim 1, wherein in the image processing apparatus to which the license return code is generated, the same license as the returned license is prevented from being registered for a certain period of time.

3. A license management method according to claim 1 further comprising the steps of:
generating a license issue code on the basis of device-specific information of an image processing apparatus to which a license is granted to issue the license; and
granting a license by registering the license issue code in the image processing apparatus having the above device-specific information.

4. A license management method according to claim 1, wherein
the generated license issue code contains a limit time for registration, and
when the license issue code is not registered in the image processing apparatus before the time limit, the license issue code is made invalid.

5. A license management method according to claim 1, wherein
a license management server connected to a network is used as the license management method.

6. An image processing apparatus comprising:
a program storage means which stores a program for performing an option function validated only while a license is granted;
an access means which can access to a license management file in which licenses are registered;
a display means which displays the licenses registered in the license management file accessed by the access means thereon;
based on that a license to be granted is identified among the licenses displayed on the display means, a means which outputs own identification information to the license management file to associate own identification information with the license to be granted and register the own identification information in the license management file; and
based on that the own identification information is registered in the license management file, a means which stores that the license is granted and validates the program stored in the program storage means for performing the option function of the license.

7. An image processing apparatus according to claim 6, wherein
the license management file is stored in a portable storage unit, and
the access means includes an interface capable of attaching the portable storage unit which stores the license management file therein.

8. An image processing apparatus according to claim 6, wherein
the access means includes a network interface for accessing to the license management file stored in a predetermined personal computer or the like via a network.

9. An image processing apparatus according to claim 6 further comprising a license return processing means
when a granted license exists in the licenses displayed on the display means, in response to an instruction to return the granted license,
cancels a valid state of the program corresponding to the license,
deletes a record that the license is granted, and
outputs an instruction to delete own identification information to the license management file.

10. A license management method of granting a license to an image processing apparatus having a program storage means which stores a program for performing an option function validated only while the license is granted to validate the program, and of managing the granted license comprising the steps of:
storing licenses in a portable storage unit;
causing an image processing apparatus which intends to acquire a license to access to the portable storage unit;
associating identification information of the accessing image processing apparatus with the license to be granted and storing the identification information in the portable storage unit;
granting the license associated with the identification information and stored in the portable storage unit to the image processing apparatus; and
preventing the license from being granted to another image processing apparatus.
